(19) United States
(12) Patent Application Publication
(10) Pub. No.: US 2001/0052051 A1
(43) Pub. Date: Dec. 13, 2001

(54) Method of controlling data access and system thereof

(76) Inventors: Young-Gey Kim, Seoul (KR); Ja-Choon Jeong, Seoul (KR)

Correspondence Address: ROBERT E. BUSHNELL, 1522 K STREET NW, SUITE 300, WASHINGTON, DC, 200051202

(21) Appl. No.: 09/878,309

(22) Filed: Jun. 12, 2001

(30) Foreign Application Priority Data
Jun. 12, 2000 (KR) 2000-32183

(51) Int. Cl. G06F 12/00

(52) U.S. Cl. 711/114; 711/147

(57) ABSTRACT

A disc processing system and method for enhancing a data processing speed and a stability in data protection is provided. The data access controlling system for controlling a data access with respect to data storage media, includes a master controller for controlling the data access, an upper controller connected to the master controller and a data/address bus, for executing a first RAID (redundant array of inexpensive discs) operational mode by a predetermined software method, and at least two lower controllers connected to the upper controller and the data/address bus, for executing a second RAID operational mode by a predetermined hardware method in order to control two or more data storage media connected to the lower portion of the system.

### CLAIM OF PRIORITY

This application makes reference to, incorporates the same herein, and claims all benefits accruing under 35 U.S.C. § 119 from my application entitled METHOD OF CONTROLLING DATA ACCESS AND SYSTEM THEREOF filed with the Korean Industrial Property Office on Jun. 12, 2000 and there duly assigned Ser. No. 2000-32183.

### BACKGROUND OF THE INVENTION

1. Field of the Invention

The present invention relates to a method of controlling a data access and a system thereof, and more particularly, to a disc processing system and method for enhancing a data processing speed and a stability in data protection.

2. Description of the Related Art

FIG. 1 schematically illustrates a conventional disc processing apparatus.

In FIG. 1, a disc drive 30 which is referred to as a disc in abbreviation has a plurality of discs each having a mutually identical and same capacity, which is connected to a disc drive controller 20. The disc drive controller 20 is connected to a master controller 10, and controls data reading and recording operations which are executed between the disc 30 and the master controller

Here, a speed of reading and recording a plurality of data blocks is limited by a capability of each block on the disc drive and a rotational speed of the disc drive.

When one or more data blocks on the disc 30 are processed, a reading or writing operation is not performed until the master controller 10 receives a signal that data can be sent from the disc 30 or a signal that data should be received to the master controller.

To solve the above problem, a seating method is used. That is, a seating method means a method that the master controller 10 does not access one disc continuously, but data blocks on a plurality of discs 30 are distributively processed to heighten a processing speed.

One of a RAID (Redundant Array of Inexpensive Discs) operational mode using a seating method is known as RAID 0.

RAID includes a number of operational modes, that is, RAID 0, RAID 1, RAID 3, RAID 4, RAID 5 and so on.

FIGS. 2 through 5 illustrate RAID operational modes.

As shown in FIG. 2, RAID 0 is not added with an error correction code such as a parity code. For example, in the case that m data blocks are written on each disc while using n discs (1, 2, . . . , n), a controller 30 accesses a data block by a data block in sequence of disc 1, disc 2, . . . , disc n according to a data access signal supplied from a master controller 10. Thus, a total of mn data blocks are written on the discs.

When RAID 0 is used, a data processing speed is enhanced. However, if any one disc is out of order, any data cannot be retrieved from other discs which have not been out of order.

Meanwhile, RAID 3 and RAID 4 use a method that a parity is written on a designated disc in order to protect data.

As shown in FIG. 4, a controller 50 records data on discs 1, 2, . . . , (n−1) among n discs each having the same capacity according to a data access signal supplied from a master controller 10. Here, RAID 3 records byte-level parity data on the remaining one disc n, and RAID 4 records block-level parity data on the remaining one disc n.

During reading, data other than parity is read.

When a disc is out of order, data including parity data is read. When a disc is out of order, data on the failed disc can be restored using a parity. However, since all parity values for restoring data are stored on a designated disc n, data cannot be restored if both one data disc and the parity disc n are simultaneously out of order.

In order to solve the above problem, RAID 5 uses a method of striping parity values and data on a plurality of discs and distributively processing the data.

As shown in FIG. 5, a controller 60 stripes a data block on each of n discs having the same capacity according to a data access signal supplied from a master controller 10 and distributively records the data block thereon. At the same time, block-level parity data P is striped on each disc and distributively recorded thereon.

In addition, during reading, data other than parity data is read. Also, when a disc is out of order, data including parity data is read. After a failed disc is replaced, data is restored using parity data.

Meanwhile, RAID 1 uses a mirroring method instead of a striping method.

As shown in FIG. 3, a controller 40 records the same data on each of two discs each having the same capacity according to a data access signal supplied from a master controller 10. During reading, data is read from one disc.

By doing so, a data processing speed is lower than that of a striping method, but a data protection function is reinforced.

Since RAID 0 and RAID 5 adopt a data striping method, respectively, a data processing speed is enhanced. However, since such existing RAID methods control the data processing speed only by software, speed enhancement is limited. Also, a number of discs are used in order to configure a large capacity storage medium. However, in this case, since a single disc drive controller reads a plurality of discs, a data processing speed is limited.

Further, since RAID 3 through RAID 5 use parity data, a data protection function is enhanced but a prefect data protection function is not provided. For example, if a disc in which parity data is stored and a data disc are out of order simultaneously, it is not nearly possible to restore data. In the case of RAID 1, a data processing speed is not only low but also it is difficult to restore data if two discs including a parity disc and a data disc are out of order simultaneously.

### SUMMARY OF THE INVENTION

To solve the above problems, it is an object of the present invention to provide a data access controlling system and method for enhancing a data processing speed and a stability of the stored data.

To accomplish the above object of the present invention, there is provided a data access controlling system for controlling a data access with respect to data storage media, the data access controlling system comprising: a master controller for controlling the data access; an upper controller connected to the master controller and a data/address bus, for executing a first RAID (redundant array of inexpensive discs) operational mode by a predetermined software method; and at least two lower controllers connected to the upper controller and the data/address bus, for executing a second RAID operational mode by a predetermined hardware method in order to control two or more data storage media connected to the lower portion of the system.

Here, it is preferable that the first RAID operational mode is one of a RAID 0 mode and one of a RAID 1 mode, a RAID 2 mode, a RAID 3 mode, a RAID 4 mode and a RAID 5 mode. Also, it is preferable that the second RAID operational mode is one of a RAID 0 mode and a RAID 1 mode.

Also, it is preferable that the two or more data storage media is at least one disc drive including a magnetic recording disc drive or an optical recording disc drive.

Also, it is preferable that the upper controller is an ordinary micro-controller. It is also preferable that the two or more lower controllers are RAID controllers of a dedicated chip for performing a RAID operation.

According to another aspect of the present invention, there is also provided a data access controlling method for controlling a data access with respect to data storage media in a data access controlling system including an upper controller, two or more lower controllers connected to the upper controller, and two or more data storage media connected to the lower controllers, the data access controlling method comprising the steps of: controlling the lower controllers at a first RAID (redundant array of inexpensive discs) operational mode of a predetermined software method in the upper controller; and controlling the two or more data storage media at a second RAID operational mode of a predetermined hardware method in the lower controllers.

Here, it is preferable that the first RAID operational mode controlling step is performed by a RAID 0 mode and one of a RAID 1 mode, a RAID 2 mode, a RAID 3 mode, a RAID 4 mode and a RAID 5 mode.

It is also preferable that the second RAID operational mode controlling step is performed by one of a RAID 0 mode and a RAID 1 mode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a conventional disc processing device;

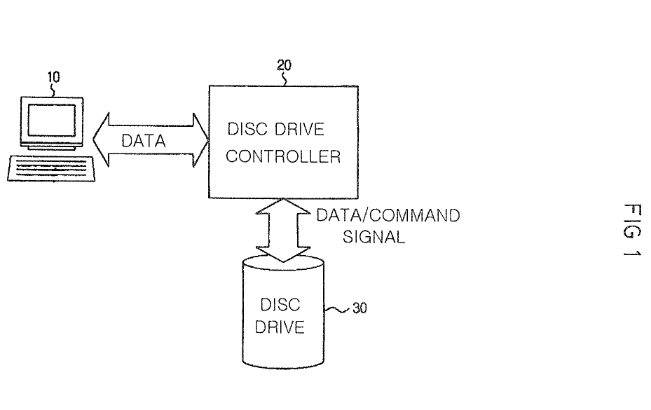

FIG. 2 is a view for explaining a RAID 0 mode;

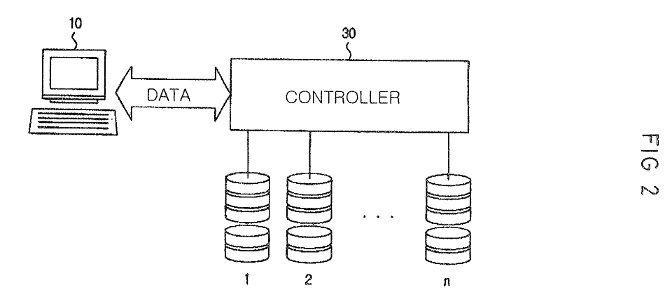

FIG. 3 is a view for explaining a RAID 1 mode;

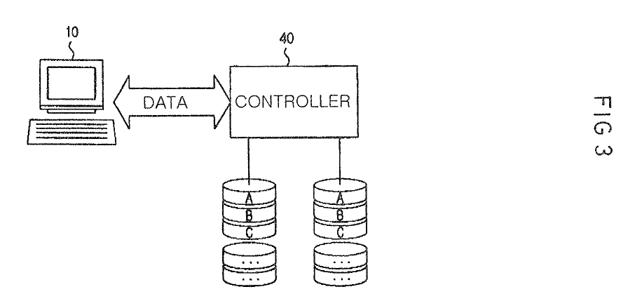

FIG. 4 is a view for explaining a RAID 3 mode and a RAID 4 mode;

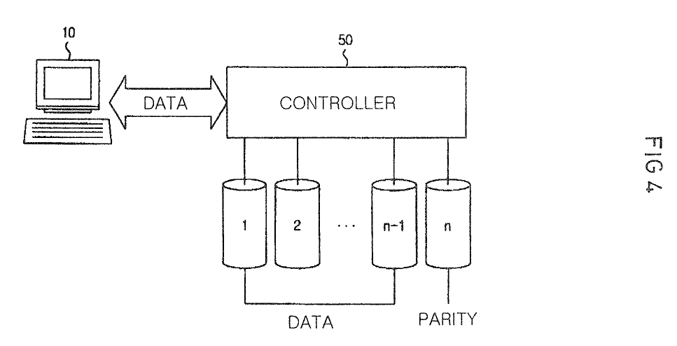

FIG. 5 is a view for explaining a RAID 5 mode;

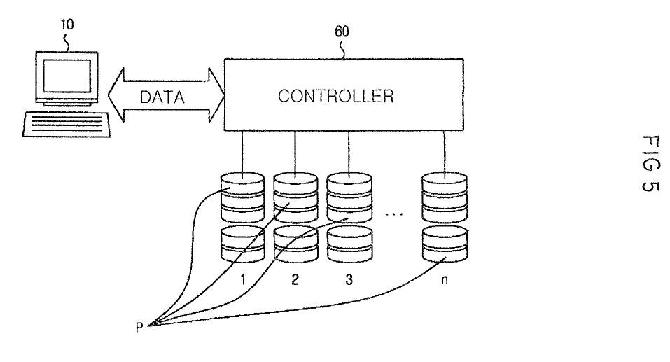

FIG. 6 illustrates a data access controlling system according to an embodiment of the present invention;

FIG. 7 is a view showing a first embodiment of the present invention; and

FIG. 8 is a view showing a second embodiment of the present invention.

### DETAILED DESCRIPTION OF THE EMBODIMENTS OF THE INVENTION

A data access controlling method and system according to each preferred embodiment of the present invention will be described in detail with reference to the accompanying drawings.

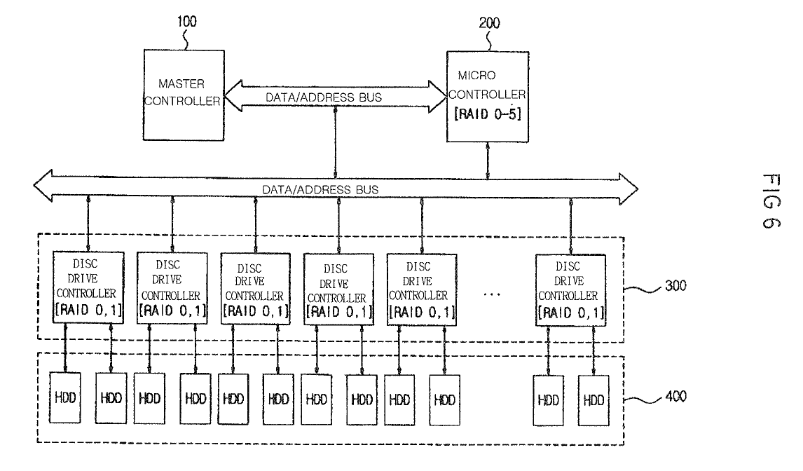

As shown in FIG. 6, a data access controlling system according to an embodiment of the present invention, includes a master controller 100 for controlling a data access, a micro-controller 200 connected to the master controller 100 via a data/address bus, for executing one of RAID 0 through RAID 5 by software, and two or more hard disc drive controllers 300 for controlling two or more hard disc drives 400 (hereinafter referred to as discs in abbreviation) using RAID 0 or RAID 1 by hardware, which provides a two-stage RAID architecture.

That is, the present invention is characterized in that RAID is configured into a multi-stage. In particular, the present invention is characterized in that tow or more dedicated RAID controllers 300 for controlling two or more discs 400 using RAID 0 or RAID 1 by hardware are positioned between the micro-controller 200 for controlling RAID 0 through RAID 5 by software and the discs 400.

For convenience of explanation, the upper portion above the disc drive controllers is called a system upper end and the lower portion below the disc drive controllers is called a system lower end, with the disc drive controllers 300 centered.

As a preferred embodiment, a case that the whole system is controlled by one of RAID 0 through RAID 5 by software and the system lower end is controlled using one of RAID 0 and RAID 1 by hardware will be described below.

First, a case that the system lowe end is controlled using RAID 0 will be described.

As described above, RAID 0 uses a striping method to thereby maximize a data processing speed. Here, if two or more disc drive controllers 300 for controlling two or more discs 400 by RAID 0 are configured by hardware, an existing limitation occurring when controlling the discs 400 by software, that is, a limit on a data processing speed and a data protection function can be overcome.

As described above, if the whole system is controlled by one of RAID 0 through RAID 5 at the system upper end, and the two or more discs 400 in the system lower end are controlled using RAID 0 by hardware, a data processing speed can be further enhanced than an existing RAID system which is controlled using one of RAID 0 through RAID 5 only by software.

Second, a case that the system end is controlled by RAID 1 will be described.

As described above, RAID 1 uses a mirroring method to thereby maximize a data protection function. Here, if two or more disc drive controllers 300 for controlling two or more discs 400 by RAID 1 are configured by hardware, an existing limitation occurring when controlling the discs 400 by software, that is, a limit on a data processing speed and a data protection function can be overcome.

As described above, if the whole system is controlled by one of RAID 0 through RAID 5 at the system upper end, and the two or more discs 400 in the system lower end are controlled using RAID 1 by hardware, a data stability can be further enhanced than an existing RAID system which is controlled using one of RAID 0 through RAID 5 only by software.

A case that the whole system is controlled by RAID 0 and the system lower end is controlled by RAID 0 which is referred to as a first embodiment of the present invention and a case that the whole system is controlled by RAID 5 and the system lower end is controlled by RAID 0 which is referred to as a second embodiment of the present invention, among various embodiments of the present invention will be described below.

### First Embodiment

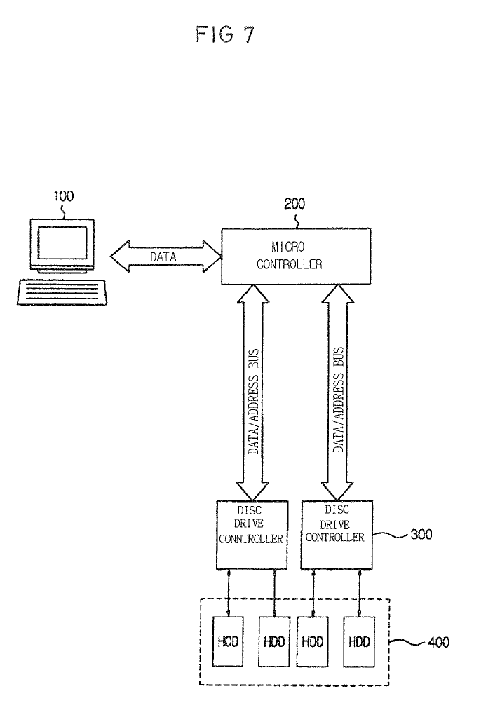

As shown in FIG. 7, a micro-controller 200 controls two disc drive controllers 300 operating in hardware by RAID 0. Each disc drive controller 300 controls two discs each having a capacity of 50 GB by RAID 0. Thus, the two disc drive controllers 300 control a total of four discs 400 by RAID 0.

Here, each maximum speed of the disc drive controllers 300 is 50 Mbyte/sec, and each speed of the discs 400 is 25 Mbyte/sec. The maximum speed of a data/address bus between the micro-controller 200 and the disc drive controllers 300 is 132 Mbyte/sec.

In the case that the system is configured as described above, the micro-controller 200 stripes data on two disc drive controllers 300 and accesses the data. Accordingly, the maximum data processing speed between the micro-controller 200 the disc drive controllers 300 is 100 Mbyte/sec (=50 Mbyte/sec×2).

Also, since each disc drive controller 300 stripes two discs, the maximum data processing speed between each disc drive controller 300 and two discs 400 is 50 Mbyte/sec (=25 Mbyte/sec×2).

Thus, the maximum data processing speed between the two disc drive controllers 300 and the four discs 400 is 100 Mbyte/sec (=50 Mbyte/sec×2).

As described above, the maximum data processing speed between the two disc drive controllers 300 and the four discs 400 is same as that between the micro-controller 200 and the two disc drive controllers 300, and is smaller than that of the data/address bus between the micro-controller 200 and the disc drive controller 300. Thus, the maximum data processing speed of the whole system is 100 Mbyte/sec.

Thus, the data processing speed in the first embodiment of the present invention is enhanced approximately two-times in comparison with the existing RAID 0 system adopting no two-stage configuration.

### Second Embodiment

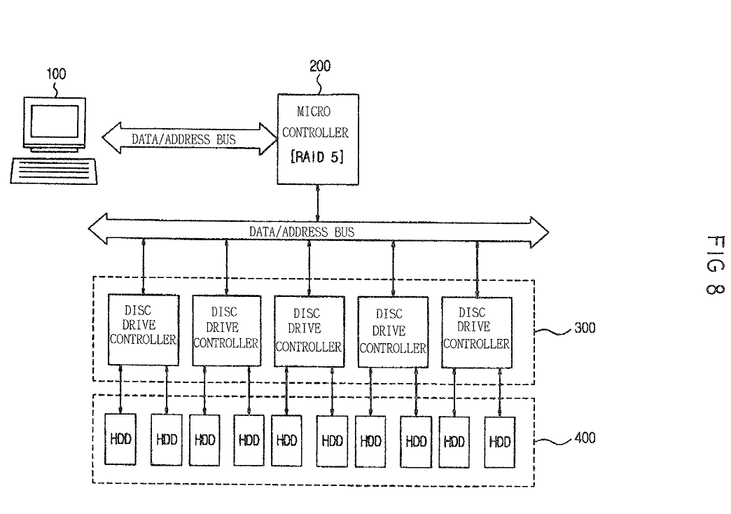

As shown in FIG. 8, a micro-controller 200 controls five disc drive controllers 300 operating in hardware by RAID 5. Each disc drive controller 300 controls two discs by RAID 5. Thus, the five disc drive controllers 300 control a total of ten discs 400 by RAID 5.

As described above, RAID 5 has a merit of enhancing a data protection function and RAID has merit of enhancing a data processing speed.

Thus, as illustrated, in the case that each disc drive controller 300 controls two discs by RAID 0 and the micro-controller 200 controls each disc drive controller 300 by RAID 5, a data processing speed is enhanced approximately two-times than the system is configured so that five discs are controlled by RAID 5.

In addition, since the whole system is controlled by RAID 5, it is apparent to a person who has an ordinary skill in the art that a data stability is guaranteed.

Also, although the present invention has been described with respect to a case that a RAID system is configured to have a two-stage speed architecture, the present invention is not limited thereto, but it is obvious that the present invention can be configured to have a multi-stage controller for controlling two or more discs.

In other words, the present invention is not limited in the above-described embodiment. It is apparent to one who is skilled in the art that there are many variations and modifications.

As described above, the present invention includes a multi-staged RAID system, to thereby enhance a data processing speed and enhances a data stability in the stored data. Thus, the RAID system can be used semi-permanently, and the stored data can be managed more efficiently and easily. The present invention is used in a data access controlling system and method for controlling a data access with respect to data storage media.

What is claimed is:

1. A data access controlling system for controlling a data access with respect to data storage media, the data access controlling system comprising:
a master controller for controlling the data access;
an upper controller connected to the master controller and a data/address bus, for executing a first RAID (redundant array of inexpensive discs) operational mode by a predetermined software method; and
at least two lower controllers connected to the upper controller and the data/address bus, for executing a second RAID operational mode by a predetermined hardware method in order to control two or more data storage media connected to the lower portion of the system.

2. The data access controlling system of claim 1, wherein said first RAID operational mode is one of a RAID 0 mode and one of a RAID 1 mode, a RAID 2 mode, a RAID 3 mode, a RAID 4 mode and a RAID 5 mode.

3. The data access controlling system of claim 1, wherein said second RAID operational mode is one of a RAID 0 mode and a RAID 1 mode.

4. The data access controlling system of claim 1, wherein said two or more data storage media is at least one disc drive including a magnetic recording disc drive or an optical recording disc drive.

5. The data access controlling system of claim 1, wherein said upper controller is an ordinary micro-controller, and said two or more lower controllers are RAID controllers of a dedicated chip for performing a RAID operation.

6. A data access controlling method for controlling a data access with respect to data storage media in a data access controlling system including an upper controller, two or more lower controllers connected to the upper controller, and two or more data storage media connected to the lower controllers, the data access controlling method comprising the steps of:
controlling the lower controllers at a first RAID (redundant array of inexpensive discs) operational mode of a predetermined software method in the upper controller; and
controlling the two or more data storage media at a second RAID operational mode of a predetermined hardware method in the lower controllers.

7. The data access controlling method of claim 6, wherein said first RAID operational mode controlling step is performed by a RAID 0 mode and one of a RAID 1 mode, a RAID 2 mode, a RAID 3 mode, a RAID 4 mode and a RAID 5 mode.

8. The data access controlling method of claim 6, wherein said second RAID operational mode controlling step is performed by one of a RAID 0 mode and a RAID 1 mode.
